(19) United States
(12) Patent Application Publication
(10) Pub. No.: US 2004/0198880 A1
(43) Pub. Date: Oct. 7, 2004

(54) Floor polish composition

(76) Inventors: Shoiji Ouchi, Kanagawa (JP); Tamio Nakamura, Kanagawa (JP)

Correspondence Address: Johnsondiversey Inc, Patent Section-M/S 509, P O Box 902, 8310 16th Street, Sturtevant, WI, 53177-0902, US

(21) Appl. No.: 10/480,861

(22) PCT Filed: Jun. 25, 2002
(86) PCT No.: PCT/US02/19853

(30) Foreign Application Priority Data
Jun. 29, 2001 (JP) 2001/198240

(51) Int. Cl. C08L 1/00

(52) U.S. Cl. 524/236; 524/556

(57) ABSTRACT

The present invention provides a floor polish composition for wooden floorings, artificial floorings made of synthetic resins, and concrete, marble and other stone floors, having superior water resistance, durability and coating property among other properties, in particular without comprising polyvalent metal compounds (heavy metals, etc); and which allows to obtain sufficient film hardness and gloss shortly after being applied and dried, exhibiting as well an excellent environmental compatibility. Such floor polish composition is realized by a composition comprising an aqueous dispersion of a polymer of ethylenic unsaturated compounds having a glass transition temperature ranging from 60 to 130° C. and an acid value ranging from 130 to 180 mg, and which does not use metal crosslinking agents.

### BACKGROUND OF THE INVENTION

1. Field of the Invention

The present invention relates to a floor polish composition suitable for wooden floorings, artificial floorings made of synthetic resins, and concrete, marble and other stone floors.

2. Description of the Related Art

Floor polish compositions are used with a view to achieve a beautiful appearance of floor materials such as wooden floorings, artificial floorings made of synthetic resins, and concrete, marble and other stone floors; and to protect the floor surface. Usually, floor polish compositions can be oil-based compositions using solvents, aqueous compositions or compositions in emulsion.

For instance, Japanese Patent Publication Nos. S47-14019 and S47-15597 disclose floor polish compositions for wooden floorings, artificial floorings made of synthetic resins, and concrete, marble and other stone floors which use polyvalent metal compounds. In the disclosed compositions, the polyvalent metal compounds, including zinc, cobalt, cadmium, nickel, chromium, zirconium, tin, tungsten, aluminium and other heavy metals form complexes with ammonia or amines.

Floor polish compositions not using these complexes have also been proposed. For instance, Japanese Patent Publication No. S60-48542 proposes a method for dispersing zinc oxide in a polymer emulsion instead of using metal complexes. The floor polish compositions are obtained through a process comprising the step of dispersing zinc oxide, for instance through stirred mixing, in an emulsion comprising an acrylic copolymer, resulting in stable compositions that do not emit amine odors during drying.

These polyvalent metal compounds are added to increase the durability, water resistance and removability of the floor polish composition, but, owing to the growing environmental awareness, it would be desirable to avoid the use of polyvalent metal compounds (heavy metals, etc).

Furthermore, since the use of zinc compounds may cause the environmental pollution by heavy metals, the use of calcium as a metal crosslinking agent has also been studied. For instance, Japanese Patent Application Laid-open No. H8-92529 discloses a floor polish composition using calcium as a metal crosslinking agent; however, this merely replaces the metal crosslinking agent by calcium, which [by itself] does not impart sufficient durability and wear resistance to the film compared with the usual zinc crosslinking agents; the aforementioned invention partially compensates this drawback by carrying out a crosslinking reaction between an aqueous urethane resin and a calcium compound.

Aqueous coating compositions have also been proposed which do not use any metal crosslinking agent at all. For instance, in Japanese Patent Application Laid-open No. 2001-2980, durability is improved by including 0.1-100 parts by mass of an amine compound for 100 parts by mass (solids) of an aqueous dispersion of a copolymer having a glass transition temperature of 80° C. or less. However, the polish according to this method involves drawbacks in that, when it is used for recoating, the amines migrate into the base coat thereby resulting in an insufficient gloss, while the increased viscosity makes the coating operation more difficult. Preferred viscosities for floor polish compositions are usually not larger than 15 mPa.s.

### SUMMARY OF THE INVENTION

In order to solve the above problems, the inventors carried out a diligent research which resulted in the present invention, whose object is to provide a floor polish composition having superior water resistance, durability and coating property among other properties, in particular without comprising polyvalent metal compounds (heavy metals, etc); and which allows to obtain sufficient film hardness and gloss shortly after being applied and dried, exhibiting as well an excellent environmental compatibility.

As a result of the present inventors, diligent research into the problems described above, it was found that floor polish compositions, having superior water resistance, durability and coating property among other properties, in particular without comprising polyvalent metal compounds (heavy metals, etc); and which allows to obtain sufficient film hardness and gloss shortly after being applied and dried, exhibiting as well an excellent environmental compatibility, could be obtained by means of a polymer of ethylenic unsaturated compounds having a specific glass transition temperature and a specific acid value.

Specifically, the first aspect of the present invention consists in a floor polish composition containing an aqueous dispersion of a polymer of ethylenic unsaturated compounds having a glass transition temperature ranging from 60 to 130° C. and an acid value ranging from 130 to 180, and which does not use metal crosslinking agents.

The second aspect of the present invention consists in a floor polish composition wherein the polymer of ethylenic unsaturated compounds is obtained from at least two kinds of monomers; one of which is acrylic acid, and contains methyl methacrylate and/or styrene as monomers.

Also, the third aspect of the present invention consists in a floor polish composition containing 0.1-100 parts by mass of an amine compound for 100 parts by mass (solids) of the polymer of ethylenic unsaturated compounds; and the fourth aspect consists in a floor polish composition comprising no amine compounds

### DESCRIPTION OF THE PREFERRED EMBODIMENTS

The embodiments of the present invention are explained below.

The polymer of ethylenic unsaturated compounds in aqueous dispersion used in the present invention has a glass transition temperature range varying form 60 to 130° C. and an acid value range varying from 130 to 180.

If the glass transition temperature of the polymer of ethylenic unsaturated compounds is lower than 60° C., the polish film will exhibit tackiness and it will be difficult to obtain a sufficient durability.

The glass transition temperature (hereinafter Tg) in the present invention is determined using the Fox Equation below:

1/Tg=W1/Tg1+W2/Tg2+W3/Tg3 [Equation 1]

where W1, W2, W3 . . . represent the weight fractions of the monomers 1, 2, 3 in the polymer; and Tg1, Tg2, Tg3 represent the glass transition temperatures (absolute temperatures) of the homopolymers (pure polymers) of the same monomers 1, 2, 3 . . .

In the equation above, the values listed in “Polymer Handbook” can be used for the Tg of the different homopolymers.

For example, poly(methyl methacrylate): 105° C., poly(butyl acrylate): −54° C., poly(2-ethyl hexyl acrylate): −50° C., poly(cyclohexyl acrylate): 19° C., polymethacrylic acid: 228° C., polyacrylic acid: 106° C., polystyrene: 100° C., etc.

The preferred acid value range for the above polymer of ethylenic unsaturated compounds used in the present invention is set to a range from 130 to 180.

With acid values below 130 it is difficult to achieve a good durability and the black heel mark (BHM) resistance is poor. On the other hand, acid values above 180 result in poor water resistance.

The acid value represents the mg of potassium hydroxide (KOH) necessary to neutralize the carboxylic acids present in 1 g of polymer. In the present invention, the theoretical acid values of the α,β-unsaturated carboxylic acids used for manufacturing the polymer of ethylenic unsaturated compounds are, for instance, 779 for acrylic acid and 652 for methacrylic acid. For instance, the theoretical acid value of a polymer containing 10% by mass of methacrylic acid would be 65, calculated through the fraction of α,β-unsaturated carboxylic acids in the polymer and rounded to the nearest integer.

In the manufacture of the polymer of ethylenic unsaturated compounds used in the present invention, ethylenic unsaturated monomers that can be used are: (a) α,β-unsaturated carboxylic acids, (b) (meth)acylates, (c) methacrylates, and (d) monomers copomerizable with α,β-unsaturated carboxylic acids or (meth)acrylates and methacrylates.

More specifically, preferred (a) α,β-unsaturated carboxylic acid compounds include for instance (meth)acrylic acid, fumaric acid, itaconic acid, maleic acid, methacrylic acid, crotonic acid, etc., and methacrylic acid is particularly preferably used. These α,β-unsaturated carboxylic acid monomers can be used singly or in combination of 2 or more.

Preferred (b) acrylates include for instance alkyl (meth)acrylates such as methyl (meth)acrylate, ethyl (meth)acrylate, n-propyl (meth)acrylate, i-propyl (meth)acrylate, n-butyl (meth)acrylate, i-butyl (meth)acrylate, n-amyl (meth)acrylate, i-amyl (meth)acrylate, hexyl (meth)acrylate, 2-ethyl hexyl (meth)acrylate, cyclohexyl (meth)acrylate, i-nonyl (meth)acrylate, decyl (meth)acrylate, hydroxymethyl (meth)acrylate, hydroxyethyl (meth)acrylate, hydroxypropyl (meth)acrylate, hydroxybutyl (meth)acrylate, hydroxyamyl (meth)acrylate, hydroxyhexyl (meth)acrylate, etc.; herein, n-butyl (meth)acrylate and 2-ethyl hexyl (meth)acrylate are preferably used. These acrylate monomers can be used singly or in combination of 2 or more.

Preferred (c) methacrylates include for instance methyl methacrylate and ethyl methacrylate, cycloalkyl methacrylates, phenyl methacrylates, benzyl methacrylates, glycidyl methacrylates, etc.; herein methyl methacrylate is preferably used. These methacrylate monomers can be used singly or in combination of 2 or more.

Preferred (d) monomers copomerizable with α,β-unsaturated carboxylic acids or (meth)acrylates and methacrylates include for instance aromatic vinyl monomers such as styrene, α,β-methyl styrene, 4-methyl styrene, 2-methyl styrene, 3-methyl styrene, 4-methoxy styrene, 2-hydroxy styrene, 4-ethyl styrene, 4-ethoxy styrene, 3,4-dimethyl styrene, 2-chlorostyrene, 3-chloorstyrene, 4-chloro-3-methyl styrene, 4-t-butyl styrene, 2,4-dichloro styrene, 2,6 dichlorostyrene, 1-vinyl naphthalene, divinyl benzene, etc.; (meth)acrylate polyesters such as benzyl (meth)acrylate, phenoxyethyl (meth)acrylate, alkyl phenoxyethyl (meth)acrylate, phenoxy diethylene glycol (meth)acrylate, phenoxy polyethylene glycol (meth)acrylate, alkyl phenol ethylene oxide (meth)acrylate,alkyl phenol propylene oxide(meth)acrylate, 2-hydroxy-3-phenoxypropyl (meth)acrylate, ethylene glycol (meth)acrylate monophthalate, ethylene glycol (meth)acrylate hydroxyethyl phthalate, etc.; epoxy compounds such as allyl glycidyl ether, glycidyl (meth)acrylate, methyl glycidyl (meth)acrylate, etc.; polyfunctional monomers such as divinyl benzene, ethylene glycol di(meth)acrylate, diethylene glycol di(meth)acrylate, triethylene glycol di(meth)acrylate, tetraethylene glycol di(meth)acrylate, propylene glycol di(meth)acrylate, dipropylene glycol di(meth)acrylate, tripropylene glycol di(meth)acrylate, tetrapropylene glycol di(meth)acrylate, butanediol di(meth)acrylate, hexanediol di(meth)acrylate, trimethylol propane tri(meth)acrylate, pentaerithritol tetra(meth)acrylate, etc.; acid amides such as (meth)acrylamide, N-methyloyl (meth)acrylamide, N-methoxy methyl (meth)acrylamide, N-butoxy methyl (meth)acrylamide, N-N′-methylene-bis-acrylamide, diacetone acrylamide, maleamide, maleimide, etc.; vinyl compounds such as vinyl choloride, vinilydene chloride, vinyl acetate, etc.; monomers containing fluorine atoms such as trifluoroethyl (meth)acrylate, pentadecafluoro octyl (meth)acrylate, etc.; silicone compounds such as γ-methacryloyl propane trimethoxy silane, silaprene FMO711 and other reactive silicones from Chisso Corp KK, etc.; aminoalkyl esters of ethylenic unsaturated carboxylic acids such as aminoethyl acrylate, dimethyl aminoethyl acrylate, butyl aminoethyl acrylate, etc.; aminoalkyl amides of ethylenic unsaturated carboxylic acids such as aminoethyl acrylamide, dimethyl aminomethyl methacrylamide, methyl aminopropyl methacrylamide, etc.; vinyl cyanide monomers such as (meth)acrylonitrile, α-chloroacrylonitrile, etc.; herein styrene is preferably used. These monomers copomerizable with α,β-unsaturated carboxylic acids or (meth)acrylates and methacrylates can be used singly or in combination of 2 or more.

Polymers of ehtylenically unsaturated compounds having a glass transition temperature of 60 to 130° C. and an acid value of 130 to 180 can be obtained by means of conventional emulsion polymerisation or suspension polymerisation.

Herein, polymers of ehtylenically unsaturated compounds are preferably obtained from at least two types of monomers, one of which is acrylic acid, and contain methyl methacrylate and/or styrene monomers. Specifically, polymers of ehtylenically unsaturated compounds consisting of at least two types of monomers comprising methacrylic acid and methyl methacrylate, polymers of ehtylenically unsaturated compounds consisting of at least two types of monomers comprising methacrylic acid and styrene, and polymers of ehtylenically unsaturated compounds consisting of at least three types of monomers comprising methacrylic acid, methyl methacrylate and styrene are preferred.

The above polymers of ehtylenically unsaturated compounds are obtained for instance as an aqueous dispersion with a concentration of 8 to 50% solids by weight, and are added to the floor polish composition of the present invention in proportions ranging from 6 to 35% solids by weight.

Apart from the polymer of ehtylenically unsaturated compounds, the floor polish composition of the present invention, is constituted by other conventional components such as plasticizers, coalescents, levelling agents, slip modifiers, wetting agents, etc.

Usable plasticizers include: phthalates such as dimethyl phthalate, diethyl phthalate, dibutyl phthalate, di-2-ethyl hexyl phthalate, diisononyl phthalate, diisodecyl phthalate, butyl benzyl phthalate, etc.; citrates such as acetyl tributyl citrate, etc.; phosphates such as tributyl phosphate, tri-2-ethyl hexyl phosphate, triphenyl phosphate, tricresyl phosphate, tributoxyethyl phosphate, etc.; dibasic esters of fatty acids such as dibutyl adipate, di-2-ethyl hexyl adipate, di-n-alkyl adipates 610, di-2-ethyl hexyl adipate, di-2-ethyl hexyl sebacate, dibutyl sebacate, di-2-ethyl hexyl sebacate, etc.; pentadiol isobutyl ester derivates, paraffin chloride, etc.

As coalescents, alcohols such as ethanol, isopropyl alcohol, etc.; polyvalent alcohols such as ehtylene glycol, etc.; glycol ethers such as dithylene glycol monomethyl ether, diethylene glycol monoethyl ether, dipropylene glycol monomethyl ether, dipropylene glycol monoethyl ether, ethylene glycol mono-2-methyl hexyl ether, diethylene glycol mono-2-ethyl hexyl ether, etc. can be used.

As levelling agents, alkali-soluble resins etc may be used, such as styrene/acrylic copolymers, styrene/α-methyl styrene/acrylic copolymers, styrene/methacrylic copolymers, diisobutylene/maleic anhydride copolymers, rosin-modified maleic acid [resins], shellac, etc. As slip modifiers the following compounds may be used: vegetal waxes such as candelilla wax, carnauba wax, rice wax, haze wax, jojoba oil, etc.; animal waxes such as bee wax, lanoline, cachalot, etc.; mineral waxes such as montan wax, ozokerite, ceresin, etc.; petroleum waxes such as paraffin wax, microcrystalline wax, petrolatum, etc.; hydrocarbon waxes such as Fischer-Tropsch waxes, etc.; and synthetic waxes such as polyethylene (oxide) waxes, polypropylene (oxide) waxes, etc.

As wetting enhancers the following compounds can be used: anionic surfactants such as fluorinated surfactants, silicone-based surfactants, high alcohol sodium alkylsulfate, sodium alkyl benzene sulfonate, sodium succinic acid dialkyl ester sulfonate, sodium alkyl diphenyl ether disulfonate, sodium polyoxyethylene alkyl sulfate, sodium polyoxyethylene alkyl phenyl ether sulfate, sodium alkane sulfonates, etc.; fatty acid esters such as polyoxyehtylene alkyl ethers, polyoxyethylene polyoxypropylene alkyl ethers, polyoxyethylene polyoxypropylene copolymers, sucrose fatty acid esters, sorbitan fatty acid esters, polyethylene glycol fatty acid esters, polyglicerine fatty acid esters, etc.; fatty acid alkanolamides such as coconut oil fatty acid alkanolamide, lauric acid diethanolamide, lauric acid/myristic acid diethanolamide, myristic acid diethanolamide, oleic acid diethanolamide, palm kernel oil fatty acid diethanolamide, etc.; non-ionic surfactants such as alkyl glycosides,etc.; alkyl betaine ampholytic surfactants such as lauryl betaine, etc.; amido betaine ampholytic surfactants such as lauroyl amidopropyl betaine, etc.; imidazoline ampholytic surfactants such as 2-alkyl-N-carboxyethyl imidazolium betaine,etc.; alkylsulfobetaine ampholytic surfactants, amidosulfobetaine ampholytic surfactants such as coco amido dimethyl hydroxypropyl sulfobetaine, etc.; and other ampholytic surfactants such as N-alkyl-β-aminopropionates, N-alkyl-β-iminodipropionates, and β-alanine ampholytic surfactants, etc.

Apart from the above, other optional components may also be used, for instance pH adjusting agents such as ammonia, preservatives, defoamers, anti-fungal agents, fragrances, dyestuffs, urethane resins, colloidal silica, optical brighteners, ultraviolet absorbing agents, etc.

Furthermore, the floor polish composition of the present invention does not contain polyvalent metal compounds (heavy metals, etc.) forming metal crosslinking agents such as, for instance: zinc oxide, calcium oxide, calcium hydroxide, aluminium hydroxide, ammine zinc carbonate, calcium ethylenediamine carbonate-ammonia, ammine zinc acetate, ammine zinc acrylate, ammine zinc malate, ammine calcium alanate, etc. Herein, polyvalent metals refer to bivalent or higher valence metals, such as beryllium, magnesium, calcium, strontium, iron, cobalt, nickel, zinc, manganese, copper, cadmium, lead, bismuth, barium, antimony, zirconium, etc., polyvalent metal compounds refer to compounds containing these polyvalent metals. Conventionally, floor polish compositions contained these polyvalent metal compounds, whereby after applying the floor polish, the metal and the acid components (methacrylic acid or acrylic acid, etc.) in the polymer (polymer of ehtylenically unsaturated compounds) reacted during the drying process through a metal crosslinking mechanism, thereby bringing about an improvement in durability, water resistance and removability; however, owing to the growing environmental awareness, it would be desirable to avoid the use of polyvalent metal compounds, etc. (heavy metals, etc).

Furthermore, the floor polish composition of the present invention may coprise amine compounds such as α-aminoalcohol, β-aminoalcohol, diethanolamine, triethanolamine, 2-amino-isohexyl alcohol, N,N-diethyl ethanolamine, N,N-dimethyl ethanolamine, aminoethyl ethanolamine, N-methyl-N,N-diethanolamine, N,N-butyl ethanolamine, N-methyl ethanolamine, 3-amino-1-propanol, etc; the content of amine compound for 100 parts by mass (solids) of the polymer of ethylenic unsaturated compounds may be 0.1 parts by weigh or less, but preferably no amine compound is present. Proportions in the formulation greater than the above often result in an unpleasant odor of the composition itself, depending on subjective appreciations.

Also, when the proportions of these amine compounds in the formulation are higher than several parts by mass for 100 parts by mass (solids) of the polymer of ethylenic unsaturated compounds, when the floor polish composition is used for recoating, several drawbacks become apparent, as the amines migrate into the base coat thereby resulting in an insufficient gloss while the increased viscosity makes the coating operation more difficult.

In the floor polish composition of the present invention, the non-volatile content of the above optional components is preferably adjusted to from about 12% by mass to about 40% by mass.

A preferred method for the manufacture of the floor polish composition of the present invention may involve the steps of adding plasticizers, coalescents, alkali-soluble resins and fluorinated surfactants to water, then adding the polymer of ethylenic unsaturated compounds, and then mixing with synthetic waxes, etc. Also, as required by the process, appropriate optional components such as pH adjusting agents like ammonia, preservatives, defoamers, anti-fungal agents, fragrances, dyestuffs, urethane resins, colloidal silica, optical brighteners, ultraviolet absorbing agents, etc. can also be added.

### EXAMPLES

The floor polish composition of the present invention is explained more in detail by means of the examples below, though it is not meant to be limited to or by them.

(1) Preparation of the Polymer of Ethylenic Unsaturated Compounds.

Polymers of ethylenic unsaturated compounds are obtained through usual emulsion polymerisation of the compositions shown in Table 1 and Table 2

In Tables 1 and 2, nBA is n-butyl acrylate, 2EHA is 2-ethyl hexyl acrylate, MAA is methacrylic acid, MMA is methyl methacrylate, ST is styrene and Tg is the glass transition temperature, respectively.

TABLE 1

| | Polymers of ethylenic | | | | |
|---|---|---|---|---|---|
| | unsaturated compounds | | | | |
| | 1 | 2 | 3 | 4 | 5 |
| nBA | 25.5 | — | 24.0 | 14.6 | 8.6 |
| 2EHA | — | 25.5 | — | — | — |
| MAA | 22.4 | 22.4 | 25.6 | 22.4 | 22.4 |
| MMA | 9.9 | 9.9 | 9.9 | 18.5 | 24.5 |
| ST | 42.2 | 42.2 | 40.5 | 44.5 | 44.5 |
| Total | 100.0 | 100.0 | 100.0 | 100.0 | 100.0 |
| Tg (° C.) | 60 | 62 | 65 | 85 | 100 |
| Acid value | 146 | 146 | 167 | 146 | 146 |
| Non-volatile | 40.3 | 40.1 | 40.0 | 40.1 | 40.1 |
| content (%) | | | | | |

TABLE 2

Polymers of ethylenic
unsaturated compounds

| | 6 | 7 | 8 | 9 |
|---|---|---|---|---|
| nBA | — | 29.0 | 20.0 | 25.2 |
| 2EHA | — | — | — | — |
| MAA | 22.4 | 22.4 | 18.0 | 28.8 |
| MMA | 33.1 | 9.9 | 22.3 | 9.9 |
| ST | 44.5 | 38.7 | 39.7 | 36.1 |
| Total | 100.0 | 100.0 | 100.0 | 100.0 |
| Tg (° C.) | 124 | 53 | 69 | 65 |
| Acid value | 146 | 146 | 117 | 188 |
| Non-volatile | 40.1 | 40.3 | 40.0 | 40.1 |
| content (%) | | | | |

(2) Preparation of the Floor Polish Composition

Using the polymers of ethylenic unsaturated compounds of Table 1 and Table 2, the floor polish compositions of examples 1 to 7 and comparative examples 1 to 7 were prepared; these are summarized in Tables 3 to 5 along with the tests carried out on them.

All these preparations follow the guidelines for “Standard formulations of aqueous floor polishes—polymer type” of the Japan Floor Polish Association.

Also, the appearance, pH, viscosity, gloss, black heel mark (BHM) resistance, tackiness, water resistance, environmental safety and composition odor of all the obtained floor polish compositions and their overall ratings were evaluated using the following test methods and evaluation criteria; the results are displayed in Tables 3 to 5.

(1) Appearance

[Test Method]

The appearance of the tested floor polish compositions was evaluated under visual inspection.

(2) pH

[Test Method]

The pH of the original solutions of the tested floor polish compositions was measured with a pH meter as set out in JIS K 3920 (Test methods for floor polishes).

(3) Viscosity

[Test Method]

The viscosity of the tested floor polish compositions was measured using a single cylinder viscometer (units mPa.s) as set out in JIS K 3920 (Test methods for floor polishes).

(4) Gloss

The tested compositions were applied three times onto homogeneous vinyl tiles (machiko S-puren No. 5626 from Toli Co.); after drying for 1 hour gloss was measured using a specular gloss meter,

as set out in JIS K 3920 (Test methods for floor polishes).

(5) Black Heel Mark (BHM) Resistance

[Test Method]

The tested compositions were applied three times onto vinyl homogeneous tiles (machiko S-puren No. 5626 from Toli Co.), after drying at room temperature for 24 hours, black heel mark was tested using a black heel mark testing machine as set out in JIS K 3920 (Test methods for floor polishes), the results were evaluated by visual inspection using a 10-point rating:

[Evaluation Criteria]

10: Very high black heel mark resistance.

6 to 9: moderate black heel mark resistance, usable.

2 to 5: insufficient black heel mark resistance, not usable.

1: Extremely lacking in black heel mark resistance.

(6) Tackiness

[Test Method]

The tested compositions were applied onto homogeneous vinyl tiles (machiko S-puren No. 5626 from Toli Co.) under a 25° C. atmosphere; after drying for 20 minutes, 12 g/cm² weights were pressed for 3 seconds onto the observed surfaces and then removed. Tackiness was rated into 3 categories:

3: no tackiness

2: slight tackiness

1: tacky

(7) Water Resistance

[Test Method]

The tested compositions were applied three times onto vinyl composition tiles (nyuu machiko V No. 33 from Toli Co.), after drying at 38° C. for 24 hours, 0.1 mL of water was added dropwise onto them, as set out in JIS K 3920 (Test methods for floor polishes). 1 hour later the bleaching of the composition vinyl tiles was evaluated visually.

[Evaluation Criteria]

Pass: no whitening observed

Fail: whitening was observed

(8) Environmental Safety

[Test Method]

It was evaluated depending on the presence or absence of polyvalent metal compounds (heavy metals, etc.) in the tested floor polish compositions.

[Evaluation Criteria]

o: absent

x: present

(9) Odor of the Compositions

[Test Method]

It was evaluated depending on the presence or absence of unpleasant odors in the tested floor polish compositions.

[Evaluation Criteria]

o: no unpleasant odors, etc.

x: unpleasant odor (amine odor)

(10) Overall Evaluation

[Test Method]

The overall usability of the tested floor polish compositions was evaluated assessing globally the results of the above evaluation items (1) to (9).

[Evaluation Criteria]

o: Highly usable

A: somewhat problematic

x: not usable

TABLE 3

| | Example | | | | |
|---|---|---|---|---|---|
| | 1 | 2 | 3 | 4 | 5 |
| Polymers of | | | | | |
| ethylenic | | | | | |
| unsaturated | | | | | |
| compounds | | | | | |
| 1 | 35.00 | | | | |
| 2 | | 35.00 | | | |
| 3 | | | 35.00 | | |
| 4 | | | | 35.00 | |
| 5 | | | | | 35.00 |
| 6 | | | | | |
| 7 | | | | | |
| 8 | | | | | |
| 9 | | | | | |
| Conventional | | | | | |
| polymers *1 | | | | | |
| Fluorinated | 1.00 | 1.00 | 1.00 | 1.00 | 1.00 |
| surfactants *2 | | | | | |
| Defoamers *3 | 0.01 | 0.01 | 0.01 | 0.01 | 0.01 |
| Wax emulsions *4 | 7.00 | 7.00 | 7.00 | 7.00 | 7.00 |
| Resin solutions *5 | 3.00 | 3.00 | 3.00 | 3.00 | 3.00 |
| Plasticizers *6 | 1.50 | 1.50 | 1.50 | 1.50 | 1.50 |
| Coalescents *5 | 6.00 | 6.00 | 6.00 | 6.00 | 6.00 |
| Crosslinking agents *8 | | | | | |
| Monoethanolamine | | | | | |
| Deionised water | Balance | Balance | Balance | Balance | Balance |
| Total | 100.00 | 100.00 | 100.00 | 100.00 | 100.00 |
| Evaluation | | | | | |
| results | | | | | |
| Appearance | Milky | Milky | Milky | Milky | Milky |
| | white | white | white | white | white |
| PH | 7.0 | 7.0 | 6.9 | 7.0 | 7.0 |
| Viscosity | 7 | 7 | 7 | 7 | 7 |
| Gloss | 95 | 95 | 95 | 95 | 95 |
| BHM | 6.5 | 6.5 | 7 | 7 | 7 |
| Tackiness | 2 | 3 | 3 | 3 | 3 |
| Water | Pass | Pass | Pass | Pass | Pass |
| resistance | | | | | |
| Environmental | ∘ | ∘ | ∘ | ∘ | ∘ |
| safety | | | | | |
| Composition | ∘ | ∘ | ∘ | ∘ | ∘ |
| odor | | | | | |
| Overall | ∘ | ∘ | ∘ | ∘ | ∘ |
| evaluation | | | | | |

*1: polymers of ethylenic unsaturated compounds, with a 50° C. glass transition point and acid value of 120
*2: fluorinated surfactant: S-100 (fluorinated surfactant from Ciba Speciality Chemicals, 1% aqueous solution)
*3: defoamer: SE-21 (defoamer from WSC Co., content 17%)
*4: wax emulsion: haitekku E-4B (polyethylene wax emulsion from Toho Chemicals, content 40%)
*5: resin: topuko LR400 resin solution (resin from Toyo Petrolight purity 30%)
*6: plasticizer: tributoxyethyl phosphate (plasticizer from FMC Co.)
*7: coalescent: diethylene glycol monoethyl ether (coalescent)
*8: crosslinking agent: aqueous solution of ammonium zinc carbonate complex (zinc content 12%)

TABLE 4

| | Example | | Comparative example | | |
|---|---|---|---|---|---|
| | 6 | 7 | 1 | 2 | 3 |
| Polymers of | | | | | |
| ethylenic | | | | | |
| unsaturated | | | | | |
| compounds | | | | | |
| 1 | | | | | |
| 2 | | | | | |
| 3 | | 35.00 | | | |
| 4 | | | | | |
| 5 | | | | | |
| 6 | 35.00 | | | | |
| 7 | | | 35.00 | | |
| 8 | | | | 35.00 | |
| 9 | | | | | 35.00 |
| Conventional | | | | | |
| polymers *1 | | | | | |
| Fluorinated | 1.00 | 1.00 | 1.00 | 1.00 | 1.00 |
| surfactants *2 | | | | | |
| Defoamers *3 | 0.01 | 0.01 | 0.01 | 0.01 | 0.01 |
| Wax emulsions *4 | 7.00 | 7.00 | 7.00 | 7.00 | 7.00 |
| Resin solutions *5 | 3.00 | 3.00 | 3.00 | 3.00 | 3.00 |
| Plasticizers *6 | 1.50 | 1.50 | 1.50 | 1.50 | 1.50 |
| Coalescents *5 | 6.00 | 6.00 | 6.00 | 6.00 | 6.00 |
| Crosslinking agents *8 | | | | | |
| Monoethanolamine | | 0.01 | | | |
| Deionised water | Balance | Balance | Balance | Balance | Balance |
| Total | 100.00 | 100.00 | 100.00 | 100.00 | 100.00 |
| Evaluation | | | | | |
| results | | | | | |
| Appearance | Milky | Milky | Milky | Milky | Milky |
| | white | white | white | white | white |
| PH | 7.0 | 7.2 | 7.0 | 7.1 | 6.8 |
| Viscosity | 7 | 7.5 | 7 | 7 | 7.5 |
| Gloss | 95 | 95 | 95 | 95 | 95 |
| BHM | 6.5 | 7 | 6 | 4.5 | 6 |
| Tackiness | 3 | 3 | 1 | 2 | 2 |
| Water | Pass | Pass | Pass | Pass | Fail |
| resistance | | | | | |
| Environmental | ∘ | ∘ | ∘ | ∘ | ∘ |
| safety | | | | | |
| Composition | ∘ | ∘ | ∘ | ∘ | ∘ |
| odor | | | | | |
| Overall | ∘ | ∘ | x | x | x |
| evaluation | | | | | |

TABLE 5

| | Comparative example | | | |
|---|---|---|---|---|
| | 4 | 5 | 6 | 7 |
| Polymers of ethylenic unsaturated | | | | |
| compounds | | | | |
| 1 | | | | |
| 2 | | | | |
| 3 | | | 35.00 | |
| 4 | | | | |
| 5 | | | | |
| 6 | | | | |
| 7 | | | | |
| 8 | | | | |
| 9 | | | | |
| Conventional polymers *1 | 35.00 | 35.00 | | 35.00 |
| Fluorinated surfactants *2 | 1.00 | 1.00 | 1.00 | 1.00 |
| Defoamers *3 | 0.01 | 0.01 | 0.01 | 0.01 |
| Wax emulsions *4 | 7.00 | 7.00 | 7.00 | 7.00 |
| Resin solutions *5 | 3.00 | 3.00 | 3.00 | 3.00 |
| Plasticizers *6 | 1.50 | 1.50 | 1.50 | 1.50 |
| Coalescents *7 | 6.00 | 6.00 | 6.00 | 6.00 |
| Crosslinking agents *8 | 3.00 | | | |
| Monoethanolamine | | 0.90 | 0.90 | |
| Deionised water | Balance | Balance | Balance | Balance |
| Total | 100.00 | 100.00 | 100.00 | 100.00 |
| Evaluation results | | | | |
| Appearance | Milky | Milky | Milky | Milky |
| | white | white | white | white |
| PH | 8.0 | 8.7 | 7.9 | 7.0 |
| Viscosity | 6 | 23 | 196 | 7 |
| Gloss | 90 | 85 | 85 | 95 |
| BHM | 7 | 7 | 7 | 4.5 |
| Tackiness | 3 | 2 | 2 | 1 |
| Water resistance | Pass | Pass | Pass | Pass |
| Environmental safety | x | ∘ | ∘ | ∘ |
| Composition odor | ∘ | x | x | ∘ |
| Overall evaluation | Δ | Δ | x | x |

The above examples 1 to 7 show that the floor polish composition of the present invention exhibits good properties as regards appearance, pH, viscosity, gloss, black heel mark resistance, tackiness, water resistance, environmental safety, composition odor and overall rating.

Comparative example 1 is an example where the Tg temperature is below the lower limit of the range according to the present invention, exhibiting a high tackiness and poor usability.

Comparative example 2 is an example where the acid value is below the lower limit of the range according to the present invention, exhibiting a deficient black heel mark (BHM) resistance and poor usability. Comparative example 3 is an example where the acid value exceeds the upper limit of the range according to the present invention, exhibiting a deficient water resistance and poor usability.

Comparative example 4, wherein the composition contains conventional polymers with metal crosslinking agents, has environmental safety problems.

Comparative examples 5 and 6, wherein the composition contains amine compounds, develop unpleasant odours and have a poor gloss. Also, the pH is slightly basic in comparative example 5, while comparative example 6 shows an extremely high viscosity, resulting in a poor usability. In comparative example 7, where the composition does not contain conventional polymers with metal crosslinking agents, there is tackiness and an extremely low black heel mark (BHM) resistance, resulting in poor usability

[Effect of the Invention]

The floor polish composition of the present invention can be used as a floor polish composition suitable for wooden floorings, artificial floorings made of synthetic resins, and concrete, marble and other stone floors.

The present invention provides a floor polish composition having superior water resistance, durability, coating property among other properties, in particular without comprising polyvalent metal compounds (heavy metals, etc); and which allows to obtain sufficient film hardness and gloss shortly after being applied and dried, exhibiting as well an excellent environmental compatibility.

1. A floor polish composition comprising an aqueous dispersion of a polymer of ethylenic unsaturated compounds having a glass transition temperature ranging from 60 to 130° C. and an acid value ranging from 130 to 180, and which does not use a metal crosslinking agent.

2. The floor polish composition according to claim 1, wherein the polymer of ethylenic unsaturated compounds is obtained from at least two types of monomers, one of which is essentially methacrylic acid, and which comprise methyl methacrylate and/or styrene as monomers.

3. The floor polish composition according to claim 1, comprising less than 0.1 parts by mass of amine compounds for 100 parts by mass (solids) of the polymer of ethylenic unsaturated compounds.

4. The floor polish composition according to claim 1, comprising no amine compounds.

5. The floor polish composition according to claim 2, comprising less than 0.1 parts by mass of amine compounds for 100 parts by mass (solids) of the polymer of ethylenic unsaturated compounds.

6. The floor polish composition according to claim 2, comprising no amine compounds.

7. The floor polish composition according to claim 3, comprising no amine compounds.
